(19) United States
(12) Patent Application Publication
(10) Pub. No.: US 2015/0205762 A1
(43) Pub. Date: Jul. 23, 2015

(54) Automated script breakdown

(71) Applicant: Tebitha Isabell Kulikowska, Chicago, IL (US)

(72) Inventor: Tebitha Isabell Kulikowska, Chicago, IL (US)

(21) Appl. No.: 13/999,150

(22) Filed: Jan. 17, 2014

(51) Int. Cl. G06F 17/21; G06F 17/24; G06F 3/0484

(52) U.S. Cl. CPC G06F 17/211; G06F 3/0484; G06F 17/24

(57) ABSTRACT

Techniques for script breaking and film scheduling are described. A script manager electronically receives a script. A cut manager assist in cutting the script into scenes by receiving input indicating a start and an end of a scene. A highlight manager receives input highlighting a plurality of elements of a scene. A conditions manager receives input indicating filming conditions of a scene. A scenes manager enables a scene to be selected and the details of that scene to be displayed. A schedule manager electronically receives the broken-down script. A scene selector enables selection of like scenes for filming on a day. This Abstract is submitted with the understanding that it will not be used to interpret or limit the scope or meaning of the claims.

### FIELD OF THE INVENTION

The present invention related to automating filming breakdown and scheduling.

### BACKGROUND

A key step in filming, such as for example commercials or movies, is the task of a script breakdown. Script breakdown comprises lining the script, transferring the script to breakdown pages, and creating a shooting schedule. Without script breakdown, the coordination of each scene to be shot is much more difficult. While no individual step is particularly difficult, the complexity of the number of moving parts makes script breakdown a daunting task. On a live action film shoot, hundreds or even thousands of crew members, actors, extras, specialists, etc. are employed. Not only cast and locations, but props, extras count and stunt doubles, multiple cameras, special equipment, etc. need to be planned and organized. In addition, what the writer intended but did not explicitly list must be accounted for and managed.

To break down a script—typically performed by an assistant director—each scene in the script is numbered in order from the beginning to the end of the script. Often scenes are not shot in sequential order, but rather organized logically, such as outdoor, daytime, nighttime, etc. scenes. To aid in logically grouping scenes, a line is drawn across the page at the bottom of each scene to designate where the scene ends.

Next, the length of each scene is determined by counting the number of pages and then dividing each page into an equal number of eighths. For example, if a scene measures one-and-a-quarter pages long, that scene is the equivalent of one page and two-eighths. Or, if a scene lasts two-and-a-half pages, that scene is considered two pages and four-eighths in length.

The specific details of each scene that may or may not be explicitly spelled out are inserted into the script's margins, such as whether the scene takes place during the daytime or at night, whether it's in an indoor location or outdoors, whether special costumes or props are needed for the scene, like a cane, etc. Also, the number of characters in the scene is noted. Each character in the script with speaking role is assigned a permanent number. For example, the leading actor could be assigned the number 1 and the lead supporting actor could be number 2, and so on.

The pertinent information that has been gathered for each scene is used in the formation of a breakdown sheet for each scene. The breakdown sheet is a list of elements needed to schedule and produce the screenplay, such as the number of characters, page count, location, wardrobe, props, etc. A breakdown sheet should always be on hand and used as a checklist during the shooting of each scene.

While some attempts to automate this process have been made, such attempts are quite expensive and fall short. For example, ScriptE software available from ScriptE Systems, LLC, 275 Route 10, Suite 220-311, Succasunna, N.J. 07876 costs $595 plus a monthly fee of $30 (as of October 2013). This product claims to automate breakdown, it is not automated at all: ScriptE software simply provides a panel in which the user does all the work of referencing and filling out the breakdown sheet manually. ScriptE software employs a tab system where the user looks at the script on one side of the software and then fills it out on the adjacent tab. Stripped-down of its bells and whistles, all ScriptE does is provides almost a spreadsheet on one tab while looking at the script on the other. Similarly, Movie Magic software available from Entertainment Partners, 220 South Flower Street, Burbank, Calif. 91502 provides similar functionality as ScriptE—simply a digital spreadsheet that allows the user to visually access what the user is doing on a computer screen.

What would therefore be desirable would be a system that truly automates the process of breaking down a script, helps avoiding human error, while being available at a price point that can be afforded by independent producers, students and the like.

### SUMMARY

Described herein are techniques for automated script breakdown that helps avoiding human error and is available at a price point that can be afforded by independent producers, students and the like. A script manager electronically receives a script. A cut manager assist in cutting the script into scenes by receiving input indicating a start and an end of a scene. A highlight manager receives input highlighting a plurality of elements of a scene. A conditions manager receives input indicating filming conditions of a scene. A scenes manager enables a scene to be selected and the details of that scene to be displayed. A schedule manager electronically receives the broken-down script. A scene selector enables selection of like scenes for filming on a day. This Abstract is submitted with the understanding that it will not be used to interpret or limit the scope or meaning of the claims.

This Summary introduces concepts in a simplified form that are further described below in the Detailed Description. This Summary is not intended to identify key features or essential features of the claimed subject matter, nor is this Summary intended to be used as an aid in determining the scope of the claimed subject matter. The term ‘techniques’, for instance, refers to device(s), system(s), method(s) and/or computer-readable instructions as permitted by the context above and throughout the document.

### BRIEF DESCRIPTION OF THE FIGURES

The detailed description refers to the following accompanying drawings:

FIG. 1 is a high-level block diagram of an example computer architecture in which script breaking techniques in accordance with one or more implementations described herein can be employed.

FIG. 2 is a high-level block diagram of an example client-server architecture in which script breaking techniques in accordance with one or more implementations described herein can be employed.

FIG. 3 is a high-level block diagram of an example client application architecture in which script breaking techniques in accordance with one or more implementations described herein can be employed.

FIG. 4 is a screen shot of an example GUI of script breaking techniques in accordance with one or more implementations described herein.

FIG. 5 is a screen shot of an example GUI of a download script screen in accordance with one or more implementations described herein.

FIG. 6 is a screen shot of an example GUI of a new script identifier pop-up window in accordance with one or more implementations described herein.

FIG. 7 is a screen shot of an example GUI of a system management screen in accordance with one or more implementations described herein.

FIG. 8 is a screen shot of an example GUI of a breakdown slide tab opened in accordance with one or more implementations described herein.

FIG. 9 is a screen shot of an example GUI of a cut screen in accordance with one or more implementations described herein.

FIG. 10 is a screen shot of an example GUI of a scenes screen in accordance with one or more implementations described herein.

FIG. 11 is a screen shot of an example GUI of a highlight drop-down window in accordance with one or more implementations described herein.

FIG. 12 is a screen shot of an example GUI of a breakdown screen in accordance with one or more implementations described herein.

FIG. 13 is a screen shot of an example GUI of a system management screen in accordance with one or more implementations described herein.

FIG. 14 is a screen shot of an example GUI of a day scheduler screen in accordance with one or more implementations described herein.

FIG. 15 is a character drop-down tab in the dropped-down position in accordance with one or more implementations described herein.

### DETAILED DESCRIPTION

### The Internet

The Internet connects a global network of computers. Network servers support hypertext capabilities that permit the Internet to link together websites. Hypertext is text displayed on a computer or other electronic devices with references (for example, hyperlinks) to other text. Users navigate the Internet through graphical user interfaces (GUI). Uniform-resource locators (URLs) identify specific websites and web pages. URLs also identify the address of the website to be retrieved from a network server. The transfer control protocol/internet protocol (TCP/IP) transfers information.

The World-Wide Web (the WWW or the Web) allows material from any computer, from any format to be translated into a common language of words, images, and addresses. The Internet typically uses a hypertext language referred to as the hypertext mark-up language (HTML). HTML permits content providers to place hyperlinks within web pages. These hyperlinks link related content or data, which may be found on multiple Internet-host computers. HTML document links retrieve remote data by use of hypertext transfer protocol (HTTP). When a user clicks on a link in a web document, the link icon in the document contains the URL that the client application employs to initiate the session with the server storing the linked document. HTTP is a protocol used to support the information transfer.

A uniform resource identifier (URI) is a string of characters used to identify a name or a resource. Such identification enables interaction with representations of the resource over a network (WWW) using specific protocols. Schemes specifying a concrete syntax and associated protocols define each URI.

### System Architecture

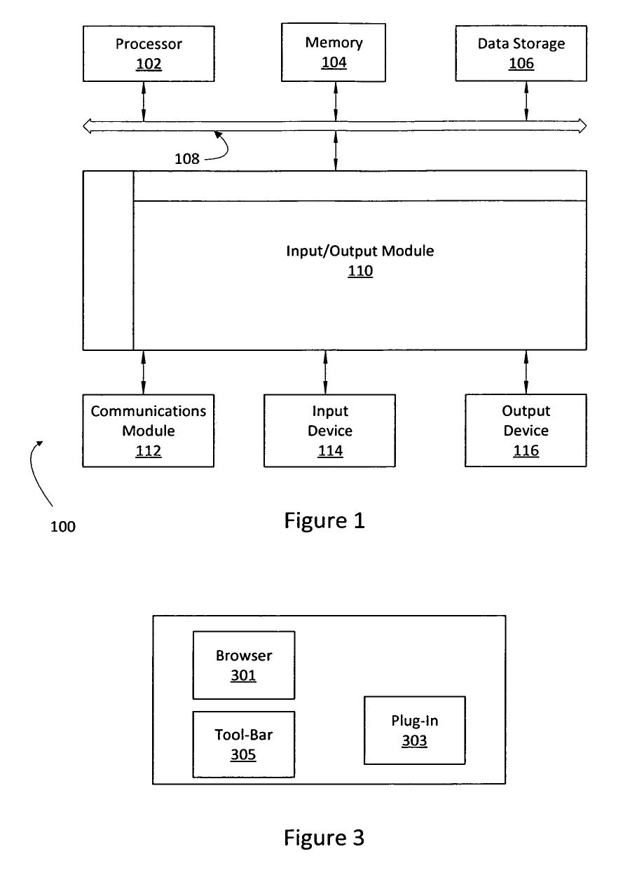

FIG. 1 displays a high-level block diagram of example system architecture in which the script breaking techniques described herein can be employed. The computer system 100 can include, in addition to hardware, computer-executable instructions stored in memory 104. A bus 108 couples the memory 104 for storing information and instructions executable by processor 102. Special purpose logic circuitry can supplement or incorporate the processor 102 and the memory 104.

The instructions may be stored in the memory 104 and implemented in one or more computer program products. Computer program products can be one or more modules of computer program instructions encoded on a computer readable medium for execution by, or to control the operation of, the computer system 100. Memory 104 may store temporary variable or other intermediate information during execution of instructions executable by the processor 102.

The computer system 100 further includes data storage 106 coupled to bus 108. The data storage 106 stores information and instructions. An input/output module 110 may couple computer system 100 to various devices. The input/output module 110 can be any input/output module. Examples of input/output modules 110 include data ports such as universal serial bus (USB) ports. The input/output module 110 is configured to connect to a communications module 112. Examples of communications modules 112 include networking interface cards, such as Ethernet cards and modems.

The input/output module 110 is configured to connect to a number of devices, such as an input 114 and/or an output 116. Examples of input devices 114 include a keyboard and a pointing device such as, for example, a mouse, by which a user can provide input to the computer system 100. Examples of output devices 116 include display devices such as, for example, a liquid crystal display (LCD) monitor for displaying information to the user.

According to one aspect, the script breaking techniques can be implemented using a computer system 100 in response to processor 102 executing one or more sequences of one or more instructions contained in memory 104. Another machine-readable medium, such as data storage 106, may read such instructions into memory 104. Execution of the sequences of instructions contained in memory 104 causes processor 102 to perform the process steps described herein.

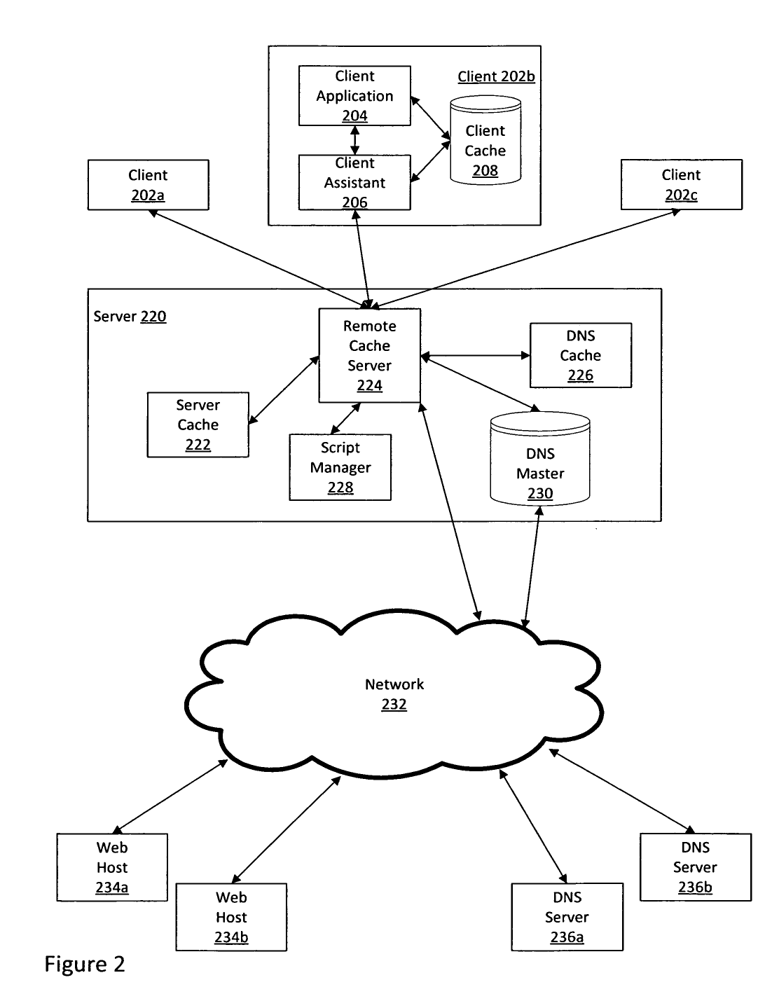

FIG. 2 illustrates a schematic of an example infrastructure of a client-server network 200, according to some implementations of the script breaking techniques described herein. The network 200 includes a number of clients 202a, 202b, 202c, and a server 220. The client 202 includes a client application 204, a client assistant 206, and a client cache 208. The client application 204 is used to support the serving of content to the client device.

The client assistant 206 may establish communication channels with the client application 204, the client cache 208, and a remote cache server 224 residing in the server 220. The client assistant 206 and the remote cache server 224 facilitate the process of responding to a content request initiated by a user of the client 202. In some implementations, cache assistant 206 may be located on a computer remote from client 202, for example, a client-side proxy server (not shown).

In some implementations, the client application 204 does not have an associated cache, but instead directs user requests to the client assistant 206. While the following discussion assumes, for ease of explanation, that the client application 204 is a web browser, the application can be any application that uses contents whose source is a network address such as, for example, a URL, whether the resource is located somewhere in the network or on the client 202.

An advantage of the implementation shown in FIG. 2 is that the web browsers or other applications in the client 202 can share the same client cache 208 and thereby avoid data duplication. But in alternative implementations, the web browser 204 may use its own cache (not shown). In such implementation, the client assistant 206 keeps the application cache 204 in sync with the client cache 208.

The server 220 includes at least a server cache 222. In some implementations, the server 220 and/or the server cache 222 are deployed over multiple computers in order to provide fast access to a large number of cached contents. For convenience of explanation, the server 220 will be referenced herein as though it were a single computer.

The server 220, through its server cache 222, manages a large number of content that have been downloaded from various web hosts 234 (for example, web servers and other hosts) over the network 232. In some implementations, the server 220 also includes a domain name system (DNS) cache 226, and a DNS master 230. In alternative implementations, server 220 does not include the DNS cache and DNS master. In some implementations, these various components co-exist in a single computer; in some other implementations, these various components are distributed over multiple computers.

The remote cache server 224 communicates with other components in the server 220 over an intranet (not shown), and communicates with web hosts 234a, 234b and domain name servers (DNS) 236a, 236b over a network 232 such as the Internet. The DNS servers 236 contain the hierarchical distributed naming system for computers, services or any resource connected to the Internet. The server 220 also includes a script manager 228 described in detail, below.

FIG. 3 displays a high-level block diagram of example client application architecture 204 in which techniques for script breaking described herein can be employed. The client 204 includes a browser 301, a browser plug-in 303, a browser toolbar plug-in 305, etc. The browser 301 retrieves, presents, and traverses information resources on the WWW. An information resource is identified by a URI and may be a web page, image, video or other piece of content. The browser plug-in 303 adds the ability of the browser to play video, scan for viruses, display new file types, and the like. The browser toolbar plug-in 305 is a graphical user interface widget on which on-screen buttons, icons, menus, or other input or output elements are placed. The browser 301 works with a password manager 228 in the server 220 in enabling the script breaking techniques.

### Script Breaking

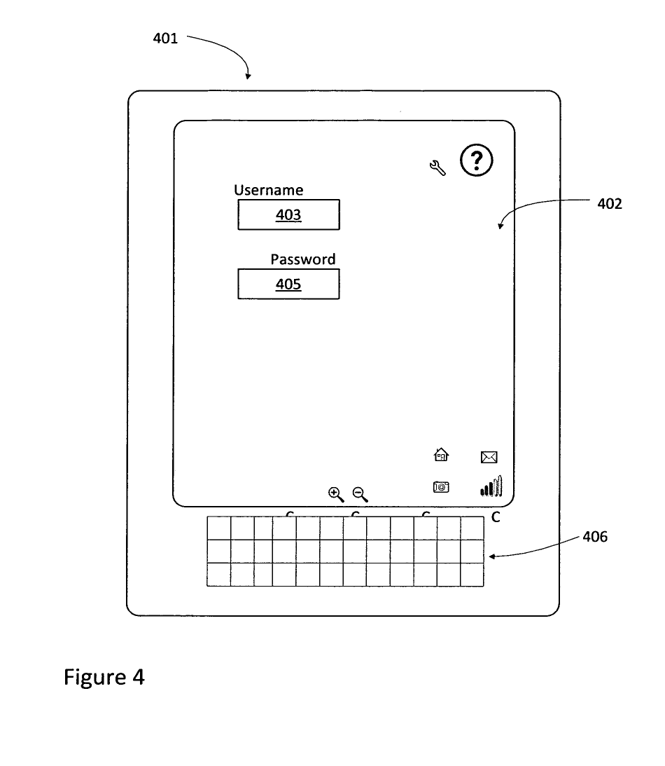

As previously introduced, techniques for improved convenience and efficiency in script breaking and film scheduling are described. Referring to FIG. 4, an example mobile client 401 showing a screen shot of an example sign-up screen is seen. The mobile client 401 includes a display screen 402 and a keypad 406. When the browser opens the login page, a ‘User Name” entry box 403 and a ‘Password’ entry box 405 are displayed.

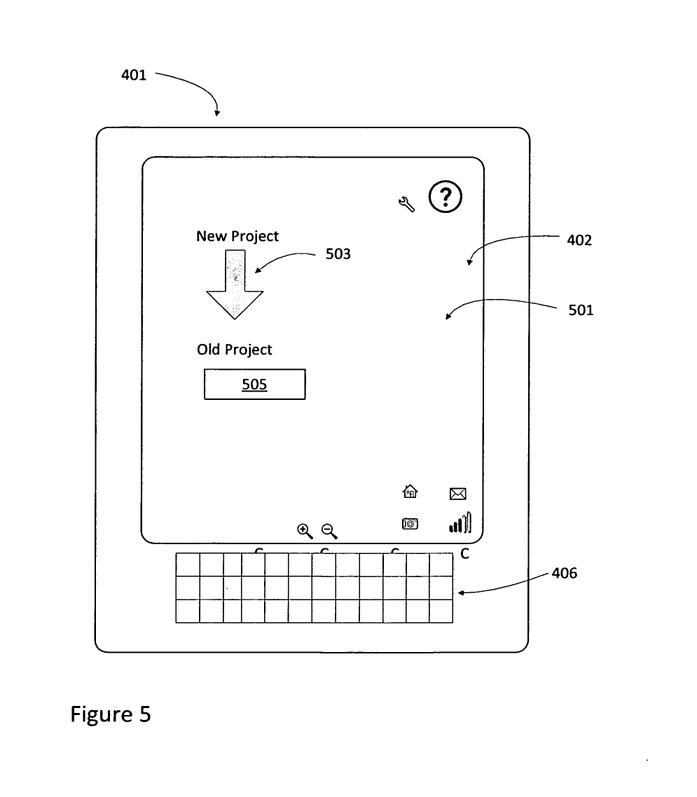

Referring to FIG. 5, after the user has signed in a download script screen 501 is displayed. If the user is entering the system to work on an existing project, an “old project” entry box 505 is selected and the project is identified, for example by a script or file name. If the user is starting a new project, a “new project” link 503 is selected to download a script. Scripts in any suitable document format such as, for example, Celtx Script, available from Celtx, P.O. Box 23126, St. John's, NewFoundLand, A1B 4J9 Canada; Adobe Story, available from Adobe Systems Incorporated, 345 Park Avenue, San Jose, Calif. 95110; Word word processing, available from Microsoft Corp., One Microsoft Way, Redmond, Wash. 98052; and the like are access via e-mail or the network.

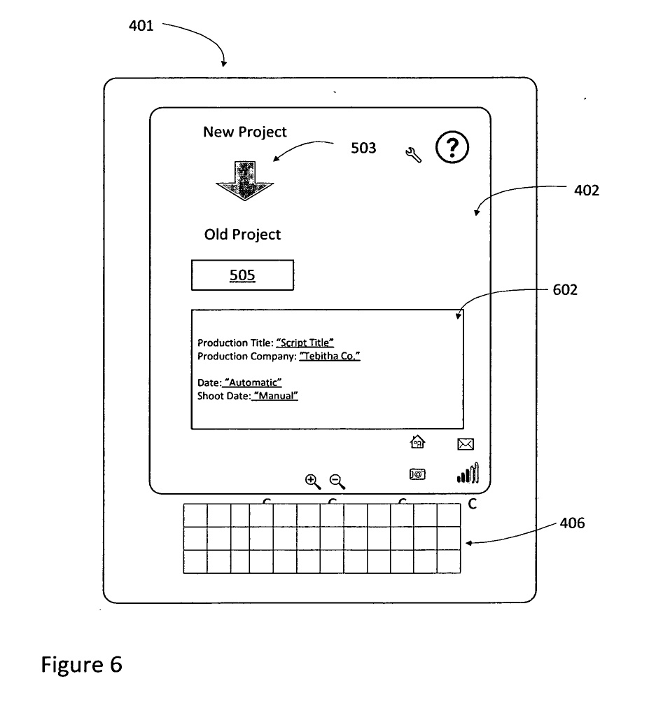

Once the script is opened, the user has an option on downloading the script into the system. The user can either save the script to the mobile client 401 with an option of opening it later or the user can download the script straight into the system. If the script is opened from e-mail straight to app, then the process goes straight into new script pop-up window described with respect to FIG. 6, below. If a user saves the script to the mobile client 401, an option to retrieve the script is available. Thus, when a user selects the “new project” link 503, an option pop up inquiries from where the user would like to grab the script from wherever the user has saved the script.

Referring to FIG. 6, if the user has indicated a new script is to be accessed, a new script pop-up window 602 appears. The new script pop-up window 602 comprises entry requests for information regarding the project such as, for example, “Production Title”, “Production Company”, “Date” [of creation] (which can be automatically filled), “Shoot Date” (which is selected by the user), and the like.

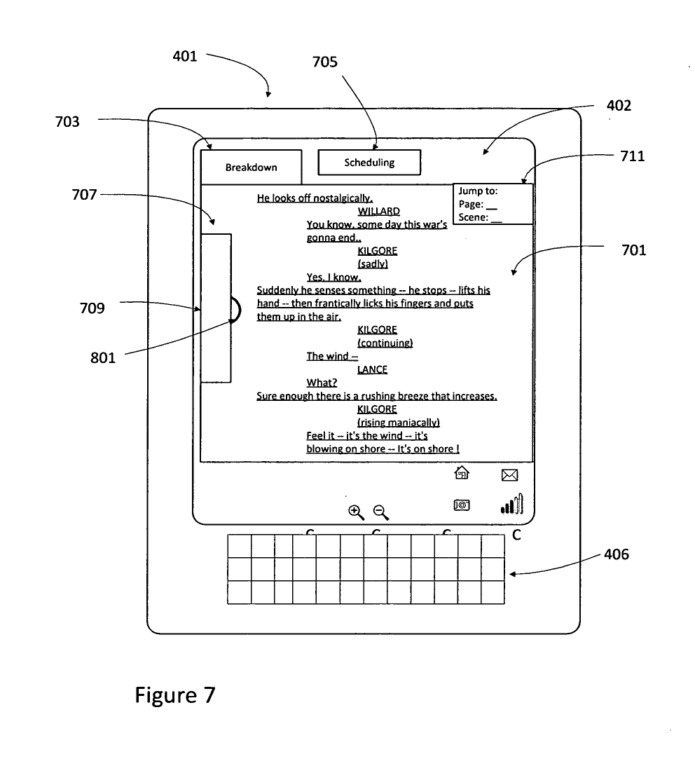

Upon either selection of an old project or filling the pop-up window with new project information, the system is accessed. Referring to FIG. 7, a system management screen 701 is seen. A script manager electronically receives a script. The script fills in the system management page. A “Breakdown” tab 703 and a “Scheduling” tab 705 are provided; in FIG. 7, the “Breakdown” manager 707 of the script manager is displayed. The “Breakdown” manager 707 includes a slide tab 709 and a “Jump to” box 711. The “Jump to” box enables the user to select where in the script to display, for example by page or scene.

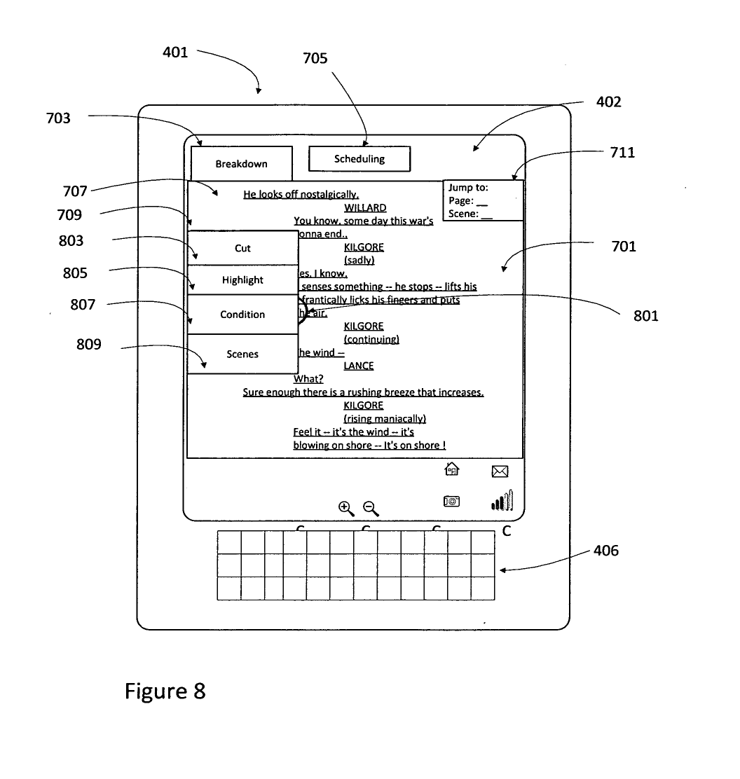

The slide tab 709 opens to reveal a plurality of breakdown functions. Referring to FIG. 8, the “Breakdown” section 707 is depicted with the slide tab 709 opened. Thus, the slide tab 709 includes a hide button 801, which alternative displays (as in FIG. 8) and hides (as in FIG. 7) the slide tab 709. The example slide tab 709 of FIG. 8 comprises a “Cut” 803 manager, a “Highlight” 805 manager, a “Condition” 807 manager, and a “Scenes” manager. While in the example described herein the various functions are labeled with words, use of appropriate icons is also contemplated such as, for example, a scissors for the “Cut” function 803, a highlighter for the “Highlight” function 805, a sun/moon for the “Condition” function 807, a clapperboard for the “Scenes” function 807, and the like. Initially, only the “Cut” function is active, with the cut function being the first step in breaking the script; once a scene is “cut” other functionality appears.

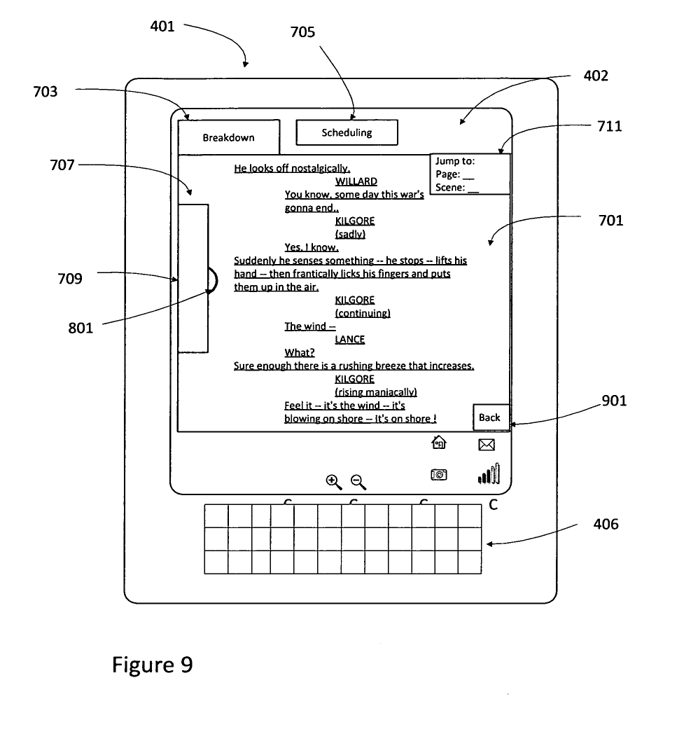

The “Cut” manager is a tool used to cut the script into a plurality of scenes. Selection of the “Cut” button again hides the slide tab 709 and adds a “Back” button 901 used to undue cutting in the event of a mistake, as seen in FIG. 9. To cut the script, the start of a scene in indicted with, for example, a first click of a “mouse” (or other input device). The end of the scene and the start of another scene are indicated with, for example, a second click of a “mouse” (or other input device). After each scene is cut, is it saved by utilizing the “Scenes” manager on the opened “Breakdown” section 707 slide tab 709.

Each scene has a condition or conditions in which the scene takes place. By selecting the “Conditions” manager 807 of the “Breakdown” section 707 slide tab 709, information on the condition or conditions of the scene can be designated. For example, the scene might need to be filmed outdoors, in daytime or nighttime. Or a scene might need to be filmed indoors. These conditions have to be clearly addressed to help with scheduling. This information is entered and appears prominently as described below.

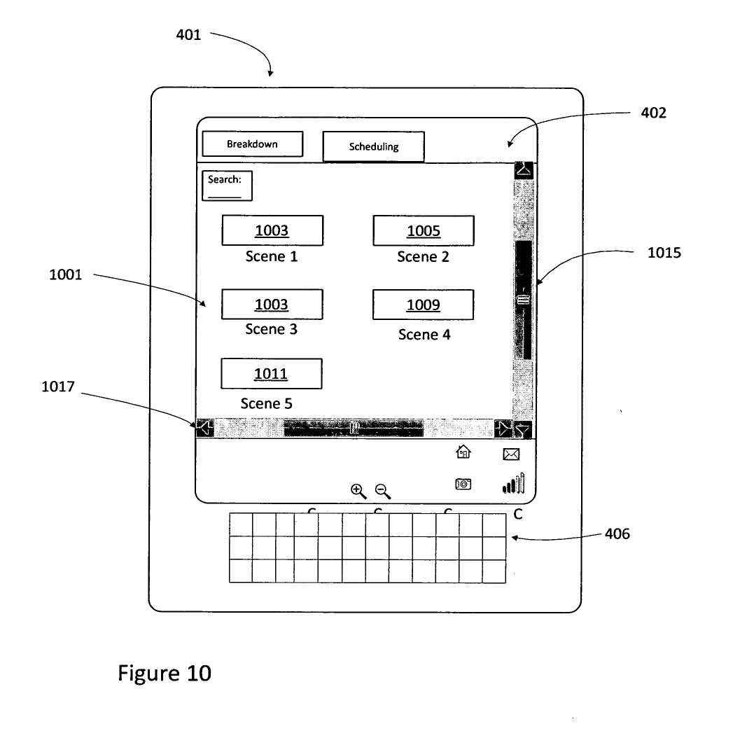

When the “scenes” manager 807 is selected, the scenes screen 1001 appears, as seen in FIG. 10. The scenes screen 1001 displays icons of the scenes that have been cut. In this example, a plurality of scene icons 1003, 1005, 1007, 1009, and 1011 correspond to scenes 1-5 of the script. A first scroll bar 915 is provided to access lower or higher scenes. A second scroll bar 1017 is provided to access the master script. The scenes can be names in a number of ways, such as for example “Scene 1”, “Opening Scene” or by an icon.

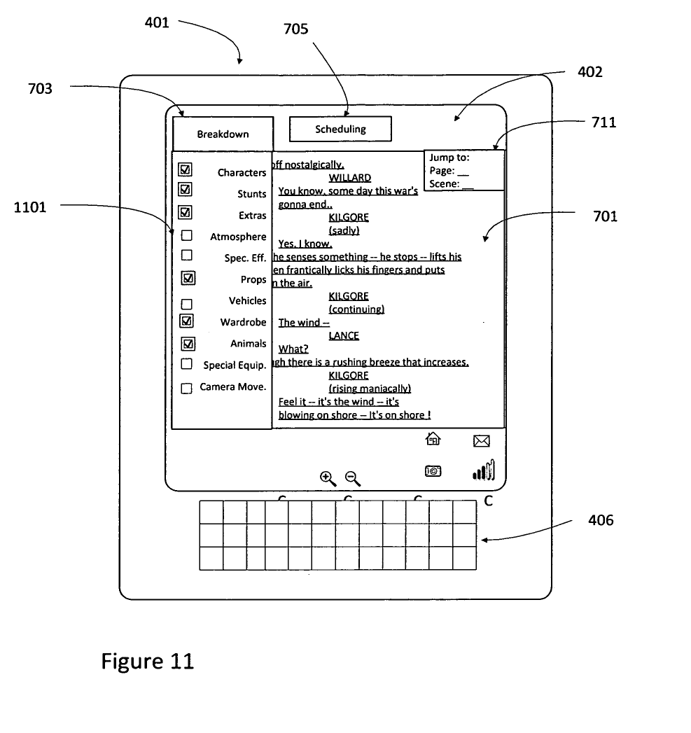

When the “Highlight” manager 805 is selected, a highlight drop-down menu 1101 appears, as seen in FIG. 11. The highlight menu 1101 includes a list of possible aspects of a scene such as, for example, characters, stunts, extras, atmosphere, special effects, props, vehicles, animals, wardrobe, special equipment, camera movement, and the like. Each category of possible aspects of a scene includes a visual identifier, such as a different color. To highlight a script an aspect is selected, the master script is accessed, and the script that corresponds to that aspect is highlighted. After the highlight option is selected, the user accesses the script and clicks on any word (via mouse, finger, etc.) which in turn is changed to the appropriate identifier of the option I chose (for example, characters are red, props are pink).

For example, if a scene (say scene 3) has Andy and Susan, and the props are a car and a baseball bat, the user can select the words “Andy” and “Susan” under characters, and “car” and “baseball bat” under props. The figure confused us because it looks like we are just selecting that a character, prop, animal etc is present in the scene but not that we are selecting this specific character or prop. Once the script of an entire scene has been highlighted, the highlighting is saved.

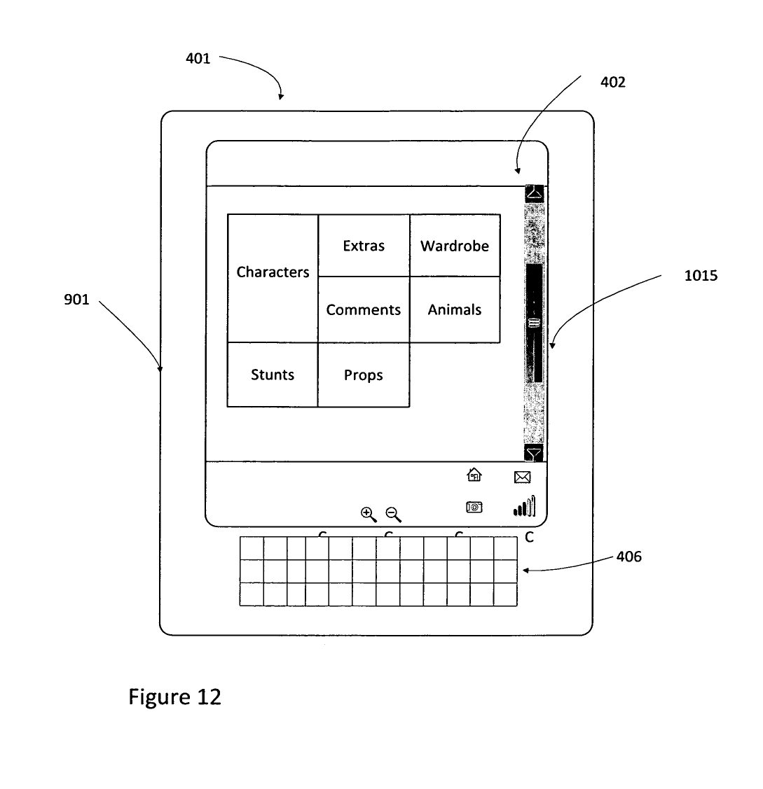

Selecting the “Scene” tab to open the scene manager opens a breakdown screen, seen in FIG. 12. A plurality of boxes is provided. A “Summary” or “Comments” box can be centered. A plurality of boxes representing script aspects can surround the “Comments” box. Each script aspect box is visually identified such as with a different color, which has been automatically populated from the highlight manager.

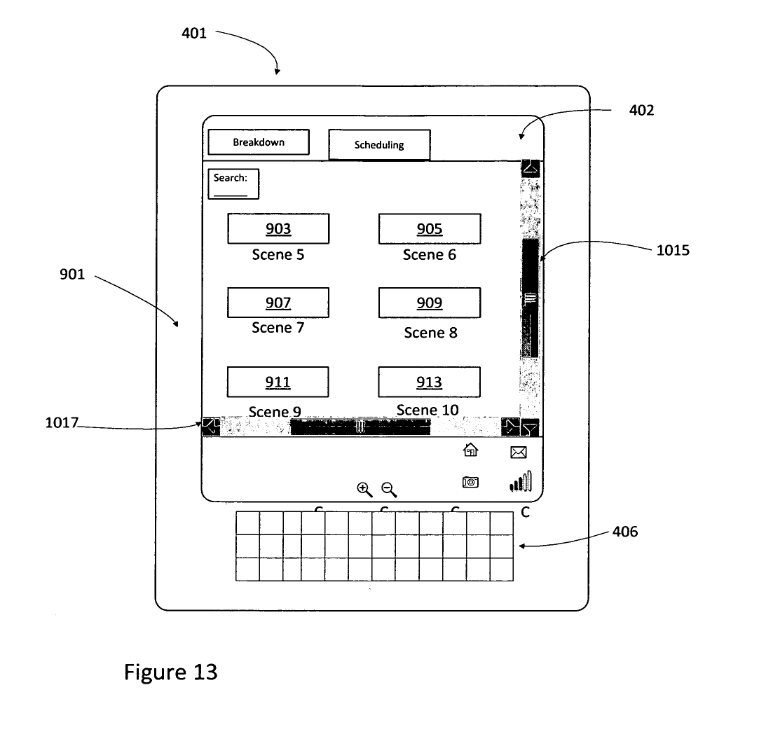

When the “Scheduling” tab 705 is selected, the scheduling manager of the system management page 701 is displayed. Referring now to FIG. 13, the scheduling manager 901 of the system management page 701 is seen. The scheduling manager 901 includes, in this example, a plurality of scene icons 903, 905, 907, 909, 911, 913 corresponding to scenes 5-10 of the script. Again, a first scroll bar 915 is provided to access lower or higher scenes and a second scroll bar 1017 is provided to access the master script.

Each scene is identified such as by color coordinated in accordance with the scene condition previously entered, such as outdoor, daytime or nighttime scenes. Thus, each day interior scene can be one color (say pink), each day exterior scene can be another (say, orange), each night interior scene color coordinated (say blue), and each night exterior scene (say green). Again, the scroll bars 1015 1017 are provided to access lower or higher scenes and the master script. A search window 917 can be provided, the use of which allows the user to search the script by character, scene, etc.

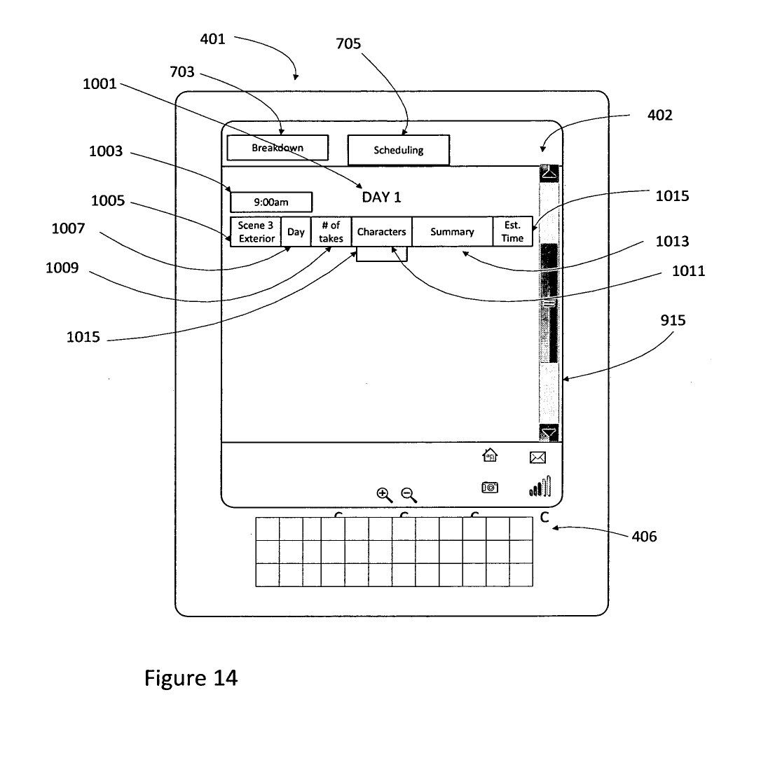

The user utilizes the scheduling system to select which scenes are to be imported into for example a “Day 1” (or other appropriately names) filming schedule. For example, referring to FIG. 14 a “Day 1” schedule 1001 is seen. In this example, “scene 3” has been imported from the scheduling section. The call time of the day (here 9:00 am) 1003 is labeled. The scene condition (here “exterior” 1005 and “day” 1007) can be automatically populated with the corresponding color code (for example, orange). The number of takes 1009—how many takes of a scene—is entered. This is the literal single sequence of the film. The main “characters” 1011 and “summary” 1013 are downloaded from the breakdown sheet. An estimate of the hours/minutes that a scene should take to film 1015 is entered.

For example, consider the following diagram:

SCRIPT>SCENE>SHOTS.

In the script, a scene includes Andy and Susan, and in the scene Andy is going to kiss Susan. The director says (s)he wants to film this scene as a “Full Wide”; this means that when Andy and Susan kiss, we see them from their feet to the top of their head. Now the director wants the same scene again, but as a “Mid Close Up”; now we see Andy and Susan kiss, but now we only see their shoulders to the top of their head. The director once again changes his mind and says he wants an “Extreme Close Up”; this again will be Andy and Susan kissing, but we only see their mouths.

“Full Wide”, “Mid Close Up”, and “Extreme Close Up” are examples of some of the types of “shots” from which a director can choose. So in the scene, the director has chosen to do the same action, but in three different “shots” or “ways of seeing” the scene. Thus, the option of selecting how many different shots the director wants to film a scene. Usually during the breakdown process, a director already has in mind how many shots (s)he wants to do of a scene. So if it is three, the user inputs “3” and then in a text box, specify which “shots” have to be done (for example, “Mid”, “Long”, “ECU”, “CU”, “Wide”, “Full”, etc. While preexisting options can be used, there are so many different names for specific shots in the film industry, in one embodiment the options can be written in.

Continuing the previous example, in scene 4 Andy and Susan kiss. The director wants want three shots of the scene. The first shot is done in five takes, while the second in seven, and the third shot in 12. In the tab of “# of takes” the number will be “24”, because the scene took 24 takes. Usually we are more concerned in how many takes the overall scene was, rather then how many takes in a shot; however, keeping in mind that there are some directors want to know that, a “notes” section can be added after the “# of takes” tab.

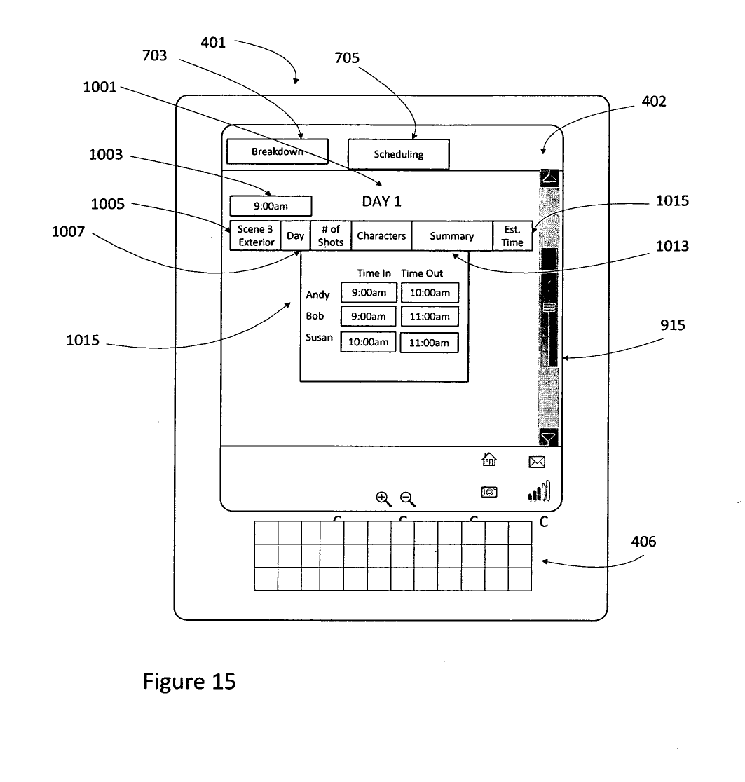

The characters include a drop-down tab 1015. Referring to FIG. 15, the character drop-down tab 1015 is seen in the dropped-down position. The character drop-down automatically populates the names of the characters' in the scene. In this example, Andy, Bob, and Susan are in the scene. A “Time In” and a “Time Out” are provided for each character. In this example, Andy is in at 9:00 am and done at 10:00 am; Bob is in at 9:00 am and done at 11:00 am; and Susan is in at 10:00 am and done at 11:00 am.

Thus, the described techniques for automated script breakdown and film scheduling help avoid human error, save time, and are available at a price point that can be afforded by independent producers, students and the like.

### CONCLUDING NOTES

The implementation described herein is not inherently related to any particular hardware or other apparatus. The operations of the script breaking techniques can be controlled through either hardware or through computer programs installed in computer storage and executed by the processors of servers.

When embodied as hardware, the hardware may be specially constructed for the required purposes or the hardware may include a general-purpose computer selectively activated or reconfigured by a computer program stored on a computer-readable medium. In addition, the implementation described herein is not limited to any particular programming language.

The password maintenance techniques may be implemented using a single computer or a network of computers, including cloud-based computing. The computers can be server-class computers including one or more high-performance central processing units (CPUs), memory such as, for example, one gigabyte (1 GB) or more of main memory, as well as 500 GB to two terabyte (2 TB) of computer-readable persistent storage, network interface, peripheral interfaces, and other well-known components.

The computers can run an operating system. Examples include the LINUX® computer-operating system or variants thereof and the like. LINUX® computer-operating system is an open-source operating system that is available under a general-public license administered by The Linux Foundation, 1796 18th Street, Suite C, San Francisco, Calif. 94107. Of course, other types of operating system and computers can be used, and it is expected that more powerful computers developed in the future can be configured in accordance with the teachings herein.

In addition to the Internet, the network may be any network. Examples of networks include local area networks (LAN), metropolitan area networks (MAN), campus area networks (CAN), wide area networks (WAN), mobile wired or wireless networks, private networks, virtual private networks, and the like. In addition, all or some of links can be encrypted using conventional encryption technologies. Examples include the SSL, secure http, virtual private networks (VPNS), and the like. Other implementations utilize custom and/or dedicated data communications technologies instead of, or in addition to, the communications technologies described above.

The terms client and content provider as used herein may refer to software providing client and content-providing functionality, to hardware devices on which the software executes or to the entities operating the software and/or hardware. The term ‘website’ represents any computer system adapted to serve content using any internetworking protocols, and is not limited to content uploaded or downloaded via the Internet or HTTP.

The term computer-readable media includes computer-storage media. Example include magnetic-storage devices such as hard disks, floppy disks, and magnetic tape; optical disks such as compact disks (CD) and digital-versatile disks (DVD); magnetic-storage devices such as digital tapes, floppy disks, and magneto-resistive-random-access memory (MRAM); non-volatile memory such as read-only memory (ROM), erasable-programmable-read-only memory (EPROMs), and electrically-erasable-programmable-read-only memory (EEPROMs); volatile memory such as random-access memory (RAM), dynamic random access memory (DRAM), ferroelectric-random-access memory (FeRAM), and static-random-access memory (SRAM); or any type of media suitable for storing electronic instructions.

Furthermore, at times arrangements of operations have been referred to by functional names, without loss of generality. The division of functionality between components, the naming of components, attributes, data structures or any other programming or structural aspect is merely exemplary, and not mandatory or significant. In addition, other implementations may distribute the described functionality in a different manner. Functions performed by a component may instead be performed by multiple components, and functions performed by multiple components may instead performed by a single component. In general, functions described in one implementation as performing on the server side can be performed on the client side in other implementations and vice versa, if appropriate.

Although the subject matter has been described with a specific implementation, other alternatives, modifications, and variations will be apparent to those skilled in the art. Accordingly, the disclosure is intended to be illustrative, but not limiting, and all such alternatives, modifications, and variations are within the spirit and scope of the following claims.

What is claimed is:

1. One or more computing devices configured to breakdown a script, the one or more computing devices comprising:
a script manager configured to electronically receive a script;
a cut manager configured to assist in cutting the script into scenes by receiving input indicating a start and an end of a scene;
a highlight manager configured to receiving as input a highlighting of a plurality of elements of a scene;
a conditions manager configured to receiving as input filming conditions of a scene; and
a scenes manager configured to enable a scene to be selected and the broken-down details of that scene to be displayed.

2. The or more computing devices configured to breakdown a script of claim 1 further comprising a schedule manager configured to electronically receive the broken-down script and a scene selector configured to enable selection of like scenes for filming on a day.

3. The or more computing devices configured to breakdown a script of claim 1 further comprising the cut manager configured to receive a mouse input indicating a start and an end of a scene.

4. The or more computing devices configured to breakdown a script of claim 1 further comprising the conditions manager configured to receiving input indicating the scene has film conditions selected from the group comprising outdoors, indoors, daytime, nighttime, and combinations thereof.

5. The or more computing devices configured to breakdown a script of claim 1 further comprising the highlights manager configured to receiving input indicating the scene has elements selected from the group comprising characters, stunts, extras, atmosphere, special effects, props, vehicles, animals, wardrobe, special equipment, camera movement, and combinations thereof.

6. The or more computing devices configured to breakdown a script of claim 1 further comprising the highlight manager configured to receive as input highlighting of different elements in the script.

7. The or more computing devices configured to breakdown a script of claim 6 further comprising the highlight manager configured to receive as input color highlighting of different elements in the script.

8. The or more computing devices configured to breakdown a script of claim 1 further comprising the scene manager configured to display icons of the scenes which, when selected, display details on that scene.

9. The or more computing devices configured to breakdown a script of claim 1 further comprising the scene manager configured to display details on a scene selected from the group comprising outdoors, indoors, daytime, nighttime, characters, stunts, extras, atmosphere, special effects, props, vehicles, animals, wardrobe, special equipment, camera movement, and combinations thereof.

10. One or more computing devices configured to schedule filming, the one or more computing devices comprising:
a schedule manager configured to electronically receive a broken-down script, including at least one condition for a scene;
a scene selector configured to enable selection of like scenes for filming on a day; and
a character manager configured to manage time of filming of characters in the scene.

11. The or more computing devices configured to schedule filming of claim 10 further comprising a scene manager configured to enable a scene to be selected and the details of that scene to be displayed.

12. The or more computing devices configured to schedule filming of claim 11 further comprising the scene manager configured to display icons of the scenes which, when selected, display details on that scene.

14. The or more computing devices configured to schedule filming of claim 10 further comprising the character manager configured to manage time in and time out of acting of characters in the scene.

15. A method implemented by one or more computing devices configured to
script bread and film schedule, the method comprising:
electronically receiving a script;
cutting the script into scenes by receiving input indicating a start and an end of a scene;
highlighting a plurality of elements of a scene;
receiving input indicating filming conditions of a scene;
electronically receive the broken-down script; and
selecting of like scenes for filming on a day.

16. The method of claim 15 further comprising receiving a mouse input indicating a start and an end of a scene.

17. The method of claim 15 further comprising receiving input comprising highlighting of different elements in the script.

18. The method of claim 15 further comprising selecting and displaying details of a scene.

19. The method of claim 15 further comprising managing time in and time out of acting of characters in the scene.
